(19) United States
(12) Patent Application Publication
(10) Pub. No.: US 2003/0200056 A1
(43) Pub. Date: Oct. 23, 2003

(54) Semiconductor device analysis system

(75) Inventor: Toshikazu Tsutsui, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/265,722

(22) Filed: Oct. 8, 2002

(30) Foreign Application Priority Data
Apr. 23, 2002 (JP) 2002-120528

(51) Int. Cl. G06F 15/00

(52) U.S. Cl. 702/183

(57) ABSTRACT

A semiconductor device analysis system is provided. In a data analysis mechanism (2a) included in a data analyzing EWS, a failure generator (11) artificially generates failure shape data about the shape of a failure assumed to occur in an actual semiconductor device. An analysis database (9) stores therein failure shape recognized data provided from a failure shape recognizer (8) and the failure shape data provided from the failure generator (11). A data processor (10) performs a failure analysis process based on the failure shape recognized data and the failure shape data.

### BACKGROUND OF THE INVENTION

1. Field of the Invention

The present invention relates to a semiconductor device analysis system for investigating the influence of semiconductor devices upon the occurrence of failures in analyzing the causes of failures in the semiconductor devices.

2. Description of the Background Art

Known techniques for detecting failures in semiconductor devices include a method employing a tester. This method recognizes the number and shape of failures based on electrical failure information obtained using the tester. In this method, a failure detected in a semiconductor device is represented by a fail bit map (referred to hereinafter as an “FBM”) indicating the position of a bit within a coordinate space defined by X and Y coordinates along a row and a column, respectively. A conventional analysis using the FBM has been performed such that contaminant and defect coordinates obtained from in-line inspection data are checked against failure information obtained by the FBM, and a contaminant or defect for which there is a match therebetween as a result of the check is judged to have an influence upon the device. Such a method of detecting failures in semiconductor devices is disclosed in, for example, Japanese Patent Application Laid-Open No. 8-293533 (1996).

However, construction of a system for recognizing the ability of a manufacturing line by the use of such a failure detection method requires actually putting a device into the manufacturing line of interest to perform an in-line inspection for each process step, thereby checking the result of the inspection against the FBM data. Thus, the use of the conventional failure detection method has been disadvantageous in that the actual process such as making comparison with the actual device inspection result is required to have a knowledge about the influence of failures upon the semiconductor device.

### SUMMARY OF THE INVENTION

It is an object of the present invention to provide a semiconductor device analysis system capable of investigating the influence of a semiconductor device upon failure occurrence without the use of an actual defect inspection result of the semiconductor device.

According to the present invention, a semiconductor device analysis system has a data analysis mechanism for analyzing a failure location and a failure shape in a semiconductor device. The data analysis mechanism includes a failure shape data generator, and a failure analysis processor. The failure shape data generator artificially generates failure shape data specifying the shape of a failure in a device. The failure analysis processor performs a failure analysis process on the failure shape data.

The semiconductor device analysis system artificially generates the failure shape data to perform the failure analysis process based on a greater number of failure shape data without the use of a result of an actual test of a semiconductor device.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a system configuration of a semiconductor device analysis system according to a first preferred embodiment of the present invention;

FIG. 2 is a detailed block diagram of a data analysis mechanism;

FIG. 3 illustrates a shape recognition result when a failure is present in a memory space defined by a two-dimensional plane;

FIG. 4 is a detailed block diagram of a data analysis mechanism in the semiconductor device analysis system according to a second preferred embodiment of the present invention;

FIG. 5 illustrates a list of defect generation parameters for establishment of a failure generation method by a failure generator;

FIG. 6 is a flowchart showing the process steps of generating failure shape data by the failure generator in the data analysis mechanism;

FIGS. 7 and 8 illustrate lists of defect generation parameters for establishment of the failure generation method by the failure generator;

FIGS. 9A, 9B and 9C illustrate examples of a wafer failure generation pattern;

FIGS. 10A and 10B illustrate examples of a chip failure generation pattern;

FIG. 11 is a flowchart showing the process steps of generating the failure shape data by the failure generator in the data analysis mechanism;

FIG. 12 is a detailed block diagram of a data analysis mechanism in the semiconductor device analysis system according to a fourth preferred embodiment of the present invention;

FIGS. 13 and 14 illustrate examples of a manipulation process by a failure data manipulation processor;

FIG. 15 is a detailed block diagram of a data analysis mechanism in the semiconductor device analysis system according to a fifth preferred embodiment of the present invention;

FIG. 16 illustrates a failure shape pattern determination process by a failure converter;

FIG. 17 is a flowchart showing a failure address calculation method by the failure converter;

FIG. 18 is a detailed block diagram of a data analysis mechanism in the semiconductor device analysis system according to a sixth preferred embodiment of the present invention;

FIG. 19 illustrates an in-line data analysis processor and its peripheral sections according to a seventh preferred embodiment of the present invention;

FIG. 20 illustrates an in-line data analysis processor and its peripheral sections according to an eighth preferred embodiment of the present invention;

FIG. 21 illustrates the failure shape pattern determination process by the failure converter in an in-line data analysis processor according to a ninth preferred embodiment of the present invention;

FIG. 22 illustrates an in-line data analysis processor and its peripheral sections according to a tenth preferred embodiment of the present invention;

FIG. 23 illustrates the failure shape pattern determination process by the failure converter in an in-line data analysis processor according to an eleventh preferred embodiment of the present invention;

FIG. 24 schematically illustrates an electrically conductive contaminant as formed on interconnect lines; and

FIG. 25 schematically illustrates a contaminant-induced failure generation mechanism.

### DESCRIPTION OF THE PREFERRED EMBODIMENTS

<First Preferred Embodiment>

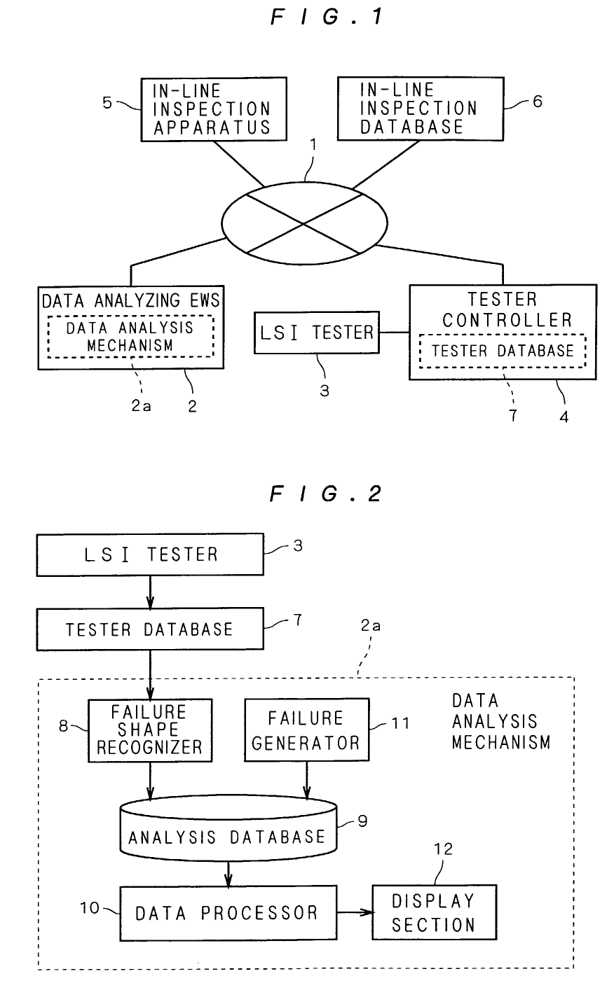

FIG. 1 is a block diagram showing a system configuration of a semiconductor device analysis system according to a first preferred embodiment of the present invention. As shown in FIG. 1, a data analyzing EWS (engineering workstation) 2, a tester controller 4, an in-line inspection apparatus 5, and an in-line inspection database 6 are connected to each other through a network 1 such as Ethernet. An LSI tester 3 is connected to the tester controller 4. The data analyzing EWS 2 contains a data analysis mechanism 2a, and the tester controller 4 contains a tester database 7.

With such a system configuration, the LSI tester 3 tests semiconductor devices for electrical failures, and the in-line inspection apparatus 5 is used for inspection in a manufacturing line of the devices. Defect data about contaminants and the like inspected by the in-line inspection apparatus 5 are stored as in-line inspection data in the in-line inspection database 6. An analysis support process by the semiconductor device analysis system is carried out by the data analysis mechanism 2a in the data analyzing EWS 2.

FIG. 2 is a detailed block diagram of the data analysis mechanism 2a. The data analysis mechanism 2a includes a failure shape recognizer 8, an analysis database 9, a data processor 10, a failure (shape data) generator 11, and a display section 12.

The LSI tester 3 conducts a test on a semiconductor device as a product for electrical failures. The results of the test by the LSI tester 3 are stored in the tester database 7 in the tester controller 4.

The test results stored in the tester database 7, e.g. a failure bit result of a memory device, have information indicating only the location of a failure. Therefore, the failure shape recognizer 8 in the data analysis mechanism 2a recognizes the shape of a failure based on a locational relationship between failures.

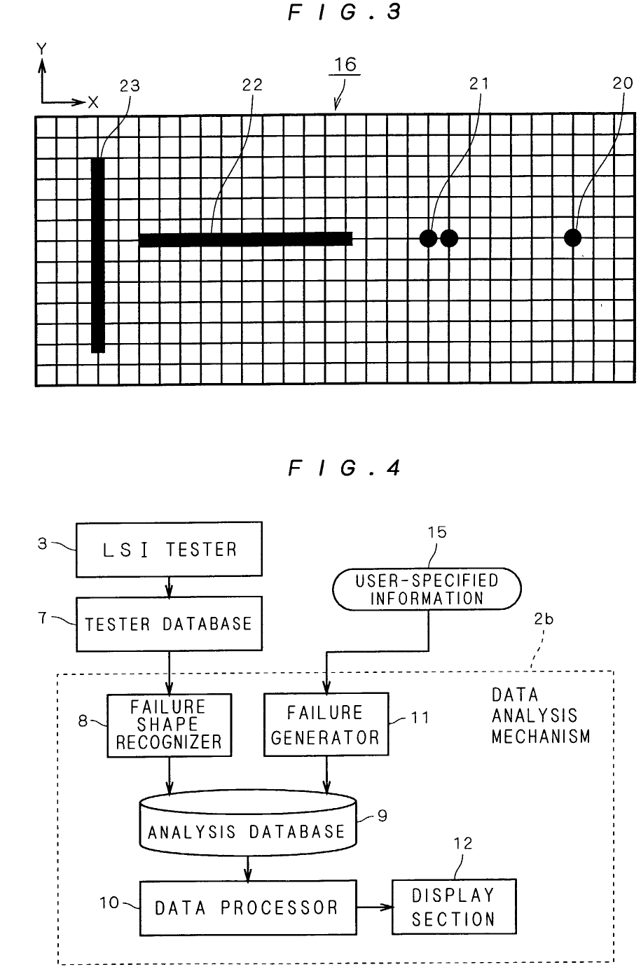

FIG. 3 illustrates a result of the shape recognition when a failure is present in a memory space defined by a two-dimensional plane. Referring to FIG. 3, assuming that a location having a piece of electrical information represented by the two-dimensional plane (X-Y plane) is referred to as a bit, the failure shape recognizer 8 recognizes and distinguishes failure shapes including a single-bit failure 20 characterized by the presence of a single failure bit, a pair-bit failure 21 characterized by the presence of a pair of adjacent failure bits, an X-line failure 22 characterized by the presence of failure bits arranged in the X direction, and a Y-line failure 23 characterized by the presence of failure bits arranged in the Y direction, based on failure location information.

For the line failure, the failure shape recognizer 8 also recognizes the length (the number of failure bits) thereof as information about the shape. The data recognized by the failure shape recognizer 8 are stored as failure shape recognized data in the analysis database 9.

The failure shape recognized data stored in the analysis database 9 are subjected to failure analysis processes by the data processor 10. The failure analysis processes include a statistical process, a data superimposition process, a fatal failure extraction process for judging whether or not a difference and a failure is fatal to a device. A list of recognition results, a statistically processed result, a failure map and the like are displayed on the display section 12 under the control of the data processor 10.

The failure generator 11 corresponding to a failure shape data generator artificially generates failure shape data about the shape of a failure assumed to occur in an actual semiconductor device.

In general, the substitution of redundant circuitry previously fabricated into a semiconductor device for an electrically failed portion which is one of the effects upon the occurrence of failures in the semiconductor device provides a remedy as an acceptable product to the semiconductor device. To optimize the redundant circuitry, it is useful to generate the failure shape data intentionally at random.

Thus, the failure shape recognized data provided from the failure shape recognizer 8 and the failure shape data provided from the failure generator 11 are stored in the analysis database 9, and the data processor 10 performs the above-mentioned failure analysis processes based on these data.

The data analysis mechanism 2a according to the first preferred embodiment has the function of generating the failure shape data artificially at random from the failure generator 11 provided therein, thereby to recognize the effectiveness of the redundant circuitry against failures without the use of an actual semiconductor device test result. For example, the data analysis mechanism 2a may verify a correlation between fatal rates provided from the data processor 10 based on the randomly generated failure shape data to provide a result serving as a guideline for determination of a circuit configuration having a higher rate at which acceptable products are provided.

As discussed hereinabove, the semiconductor device analysis system according to the first preferred embodiment comprises the failure generator 11 incorporated therein for artificially generating the failure shape data, thereby to perform, upon a large number of artificially generated data, the failure analysis process such as verification of the redundant circuitry which has not been verifiable without actual data.

<Second Preferred Embodiment>

Although the failure shape data are generated at random in the first preferred embodiment, the failure shape data are generated which have a regularity based on user-specified information 15 according to a second preferred embodiment of the present invention.

FIG. 4 is a detailed block diagram of a data analysis mechanism 2b in the semiconductor device analysis system according to the second preferred embodiment of the present invention. The overall configuration of the second preferred embodiment is similar to that of the first preferred embodiment shown in FIG. 1.

As shown in FIG. 4, the failure generator 11 generates the failure shape data based on the user-specified information 15. The user-specified information 15 specifies the number of failure chips in a wafer, the number of failures per chip, the size of a failure, and the like. Thus, a user can set the shape and size of a failure by using the user-specified-information 15.

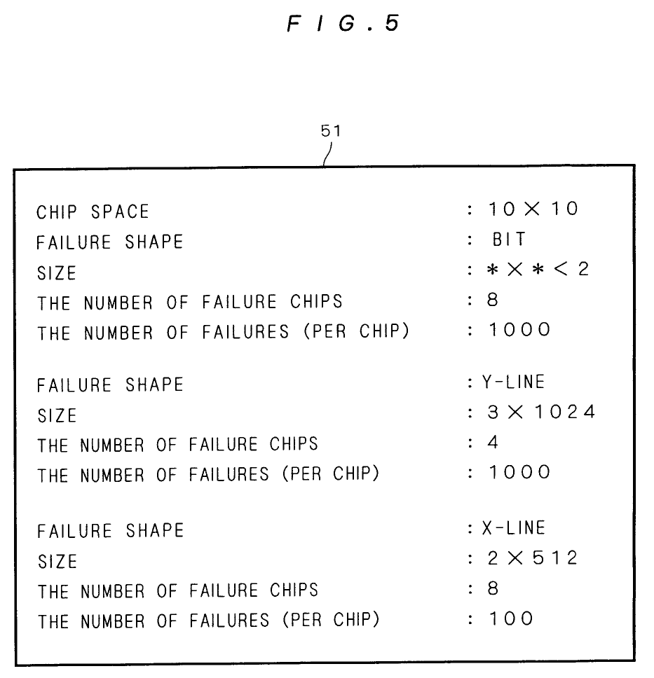

FIG. 5 illustrates a list of failure generation parameters 51 for establishing a method of generating a failure by the failure generator 11.

In FIG. 5, the parameter “CHIP SPACE” specifies a space defined by X and Y coordinates of a chip in which a failure having a predetermined failure shape is to be generated, and the parameter “FAILURE SHAPE” is a definition name when the parameter is produced. The parameter “SIZE” indicates the width (in bits)×length (in bits) of a failure. Since there are many cases, in particular, when applying bit failures to failure sizes, the size of the bit failure is defined as “random (*)×random (*)<2 (maximum)” so that the length and width equal to or less than the maximum value of “2” are generated at random. The size of the X- and Y-line failures, which have a few types of length and are easy to establish, is determined only by the width and length.

The number of failure chips per wafer (randomly definable) may be specified based on the parameter “THE NUMBER OF FAILURE CHIPS,” and the degree of failures, that is, the number of failures to be generated per chip may be specified by the parameter “THE NUMBER OF FAILURES (PER CHIP).” A chip coordinate (or chip coordinates) may be directly written into the parameter “THE NUMBER OF FAILURE CHIPS” to directly specify the chip location.

In the list of failure generation parameters 51 of FIG. 5, it is possible not only to define the bit failure, the X-line failure and the Y-line failure to thereby define the failure shape merely in a specific chip, but also to generate a plurality of types of failure shapes permitted to overlap at some failure chips in a wafer, to thereby produce failures complexly mixed with other failures.

Although not shown in FIG. 5, other failures may be produced, for example, a block failure determined by any X and Y dimensions. Since the redundant circuitry is in some cases provided separately for each of the X and Y directions, the verification may be facilitated by allowing the user-specified information 15 to make settings having a deviation for each generated failure. For example, a redundant circuitry configuration having X-line resistance may be produced for a device in which the X-line failure is prone to occur because of the process, and the verification with attention directed toward the X-line failure will be a verification closer to device characteristics.

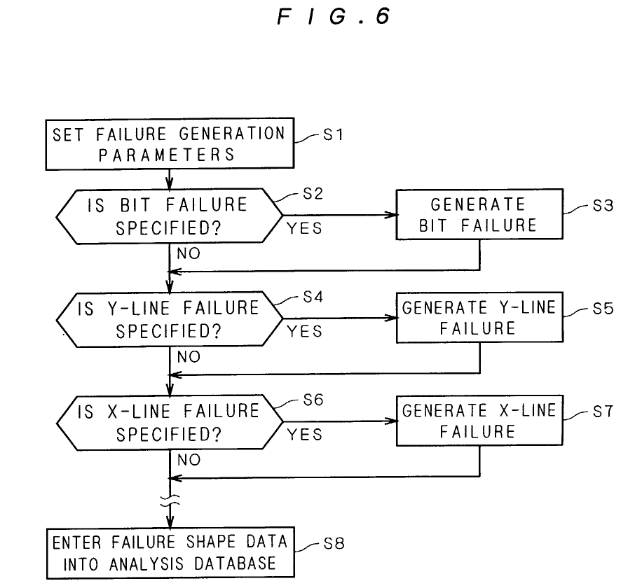

FIG. 6 is a flowchart showing the process steps of generating the failure shape data by the failure generator 11 in the data analysis mechanism 2b.

With reference to FIG. 6, the failure generation parameters 51 are previously set in Step S1.

In Step S2, whether or not the user-specified information 15 specifies the bit failure is verified. If the user-specified information 15 specifies the bit failure, the failure generator 11 generates the failure shape data about the bit failure based on “FAILURE SHAPE: BIT” in the list of failure generation parameters 51 in Step S3, and thereafter the processing proceeds to Step S4. If the user-specified information 15 does not specify the bit failure, the processing proceeds directly to Step S4.

Next, in Step S4, whether or not the user-specified information 15 specifies the Y-line failure is verified. If the user-specified information 15 specifies the Y-line failure, the failure generator 11 generates the failure shape data about the Y-line failure based on “FAILURE SHAPE: Y-LINE” in the list of failure generation parameters 51 in Step S5, and thereafter the processing proceeds to Step S6. If the user-specified information 15 does not specify the Y-line failure, the processing proceeds directly to Step S6.

Then, in Step S6, whether or not the user-specified information 15 specifies the X-line failure is verified. If the user-specified information 15 specifies the X-line failure, the failure generator 11 generates the failure shape data about the X-line failure based on “FAILURE SHAPE: X-LINE” in the list of failure generation parameters 51 in Step S7, and thereafter the processing proceeds to Step S8. If the user-specified information 15 does not specify the X-line failure, the processing proceeds directly to Step S8.

Finally in Step S8, the failure shape data generated in Steps S3, S5 and S7 are entered into the analysis database 9. The number of failure chips generated in Steps S3, S5 and S7 is determined based on “THE NUMBER OF FAILURE CHIPS” in the list of failure generation parameters 51.

As discussed above, the second preferred embodiment individually specifies the failure generation method for each failure shape, based on the user-specified information 15. Therefore, the data processor 10 can adapt to circuit optimization against failures more efficiently and more flexibly to perform the failure analysis process.

<Third Preferred Embodiment>

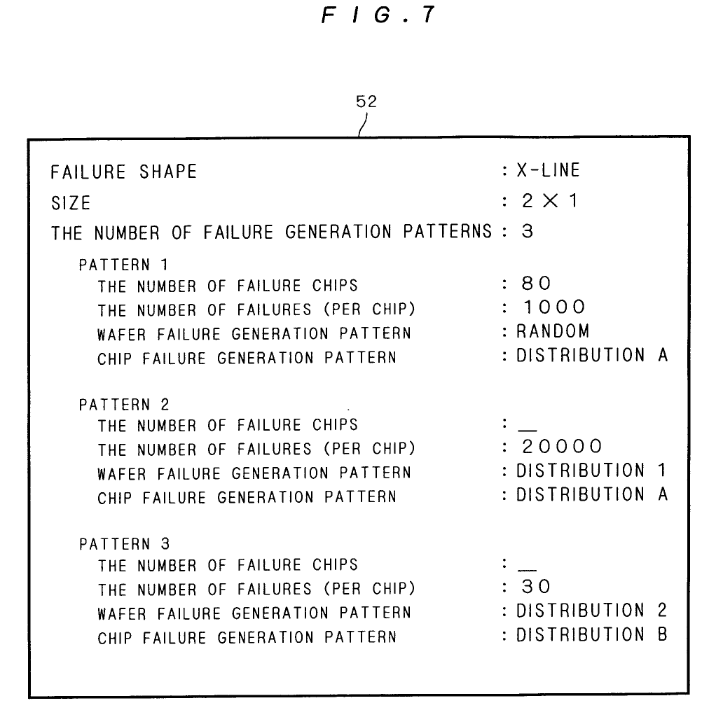

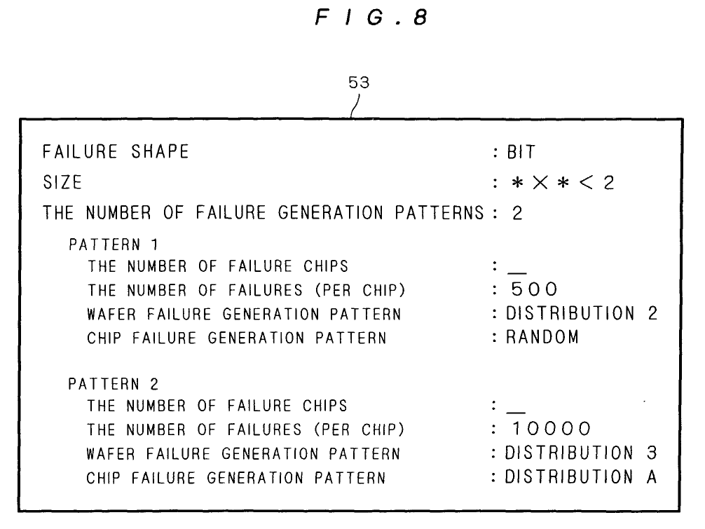

FIGS. 7 and 8 illustrate lists of failure generation parameters 52 and 53 for establishing a method of generating a failure by the failure generator 11 in the semiconductor device analysis system according to a third preferred embodiment of the present invention. The data analysis mechanism 2b of the third preferred embodiment is similar in construction to that of the second preferred embodiment shown in FIG. 4. The overall configuration of the third preferred embodiment is similar to that of the first preferred embodiment shown in FIG. 1. The third preferred embodiment differs from the second preferred embodiment in that the presence/absence of the regularities of a wafer distribution and a chip distribution are specifiable as the user-specified information 15.

As illustrated in FIGS. 7 and 8, a wafer failure generation pattern and a chip failure generation pattern are newly designated for each of the X-line failure and the bit failure. The parameters “FAILURE SHAPE,” “SIZE,” “THE NUMBER OF FAILURE CHIPS” and “THE NUMBER OF FAILURES (PER CHIP)” are similar to those of the second preferred embodiment and are not particularly described.

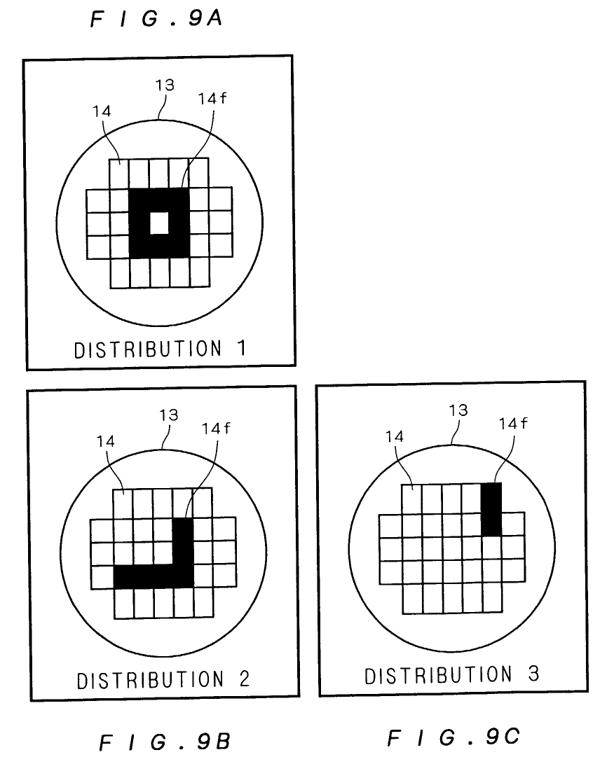

FIGS. 9A, 9B and 9C illustrate examples of the wafer failure generation pattern. With an arrangement of a plurality of chips 14 in a wafer 13, a distribution of failure chips 14f arranged in a rectangular shape in the central portion of the wafer 13 is designated as “DISTRIBUTION 1,” as illustrated in FIG. 9A. A distribution of failure chips 14f arranged in a reversed L-shape is designated as “DISTRIBUTION 2,” as illustrated in FIG. 9B. A distribution of failure chips 14f in the upper right-hand portion of the wafer 13 is designated as “DISTRIBUTION 3,” as illustrated in FIG. 9C.

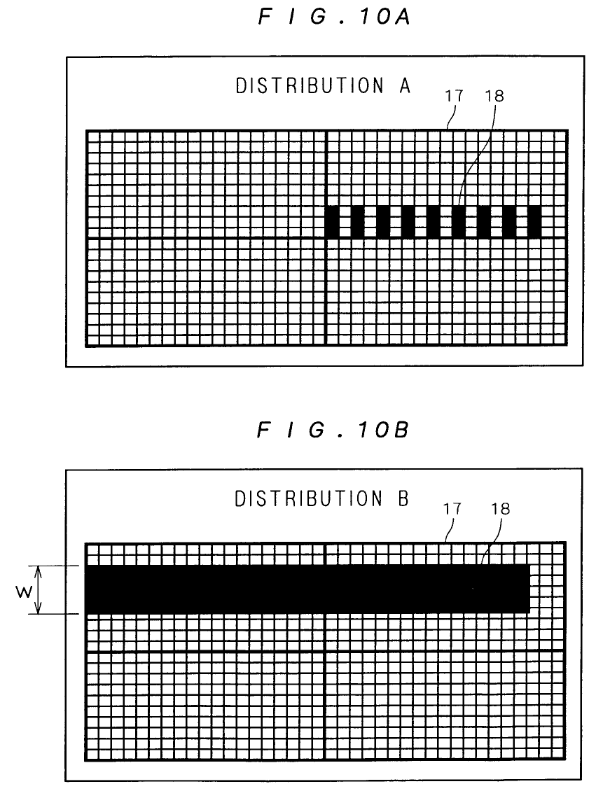

FIGS. 10A and 10B illustrate examples of the chip failure generation pattern. A distribution having a failure pattern 18 scattering rightwardly from the central portion of a chip 17 is designated as “DISTRIBUTION A,” as illustrated in FIG. 10A. A distribution having a failure pattern 18 continuous from the upper left-hand portion to the upper right-hand portion of the chip 17 with a width w is designated as “DISTRIBUTION B,” as illustrated in FIG. 10B.

The failure generator 11 of the third preferred embodiment previously stores therein the failure generation patterns shown in FIGS. 9A, 9B, 9C, 10A and 10B.

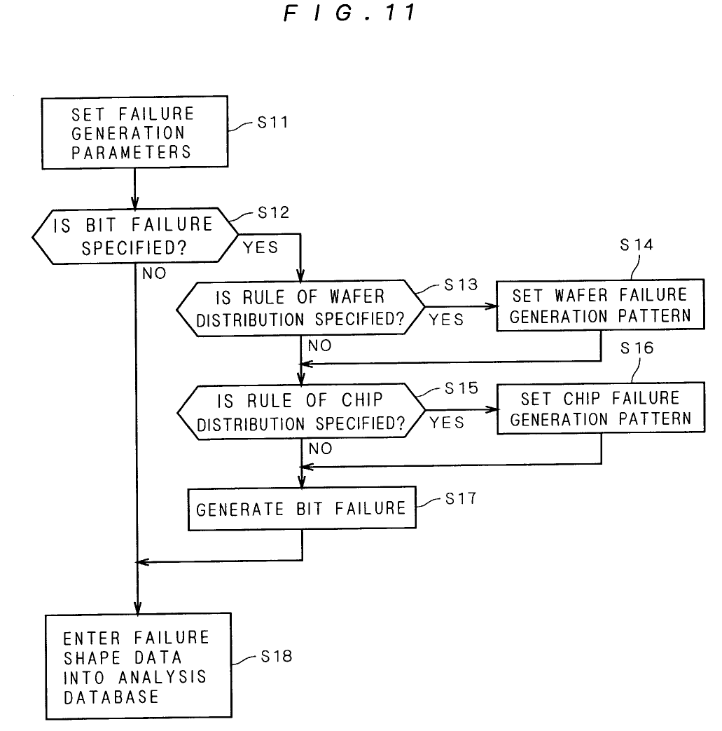

FIG. 11 is a flowchart showing the process steps of generating the failure shape data by the failure generator 111 in the data analysis mechanism 2b.

With reference to FIG. 11, the failure generation parameters 53 are previously set in Step S11.

In Step S12, whether or not the user-specified information 15 specifies the bit failure is verified. If the user-specified information 15 specifies the bit failure, the processing proceeds to Step S13. If the user-specified information 15 does not specify the bit failure, the processing proceeds directly to Step S18.

In Step S13, whether or not the user-specified information 15 specifies the regularity of the wafer distribution is detected. If the user-specified information 15 specifies the regularity, the processing proceeds to Step S14. If the user-specified information 15 does not specify the regularity, the processing proceeds to Step S15.

In Step S14, the wafer failure generation pattern is set. Specifically, based on the failure generation parameters 53 for the bit failure, the wafer failure generation pattern is set to “DISTRIBUTION 2” (See FIG. 9B) in the case of “PATTERN 1” of the bit failure, and set to “DISTRIBUTION 3” (See FIG. 9C) in the case of “PATTERN 2” of the bit failure.

In Step S15, whether or not the user-specified information 15 specifies the regularity of the chip distribution is detected. If the user-specified information 15 specifies the regularity, the processing proceeds to Step S16. If the user-specified information 15 does not specify the regularity, the processing proceeds to Step S17.

In Step S16, the chip failure generation pattern is set. Specifically, based on the failure generation parameters 53 for the bit failure, the chip failure generation pattern is set to “RANDOM” in the case of “PATTERN 1” of the bit failure, and set to “DISTRIBUTION A” (See FIG. 10A) in the case of “PATTERN 2” of the bit failure.

In Step S17, the failure shape data designating the bit failure is generated based on the settings of the wafer failure generation pattern and the chip failure generation pattern.

Thereafter, the failure shape data is entered into the analysis database 9 in Step S18 (although the failure shape data designating the bit failure is not entered when the answer to Step S12 is NO).

Although only the process based on the presence/absence of the bit failure is illustrated in the flowchart of FIG. 11 for purposes of illustration, the failure generator 11 according to the third preferred embodiment, of course, can perform the process for the X-line failure based on the user-specified information 15 and the failure generation parameters 52.

As described above, the third preferred embodiment provides characteristics to the distributions based on the wafer failure generation pattern and the chip failure generation pattern to generate failures with a closer-to-practical level.

<Fourth Preferred Embodiment>

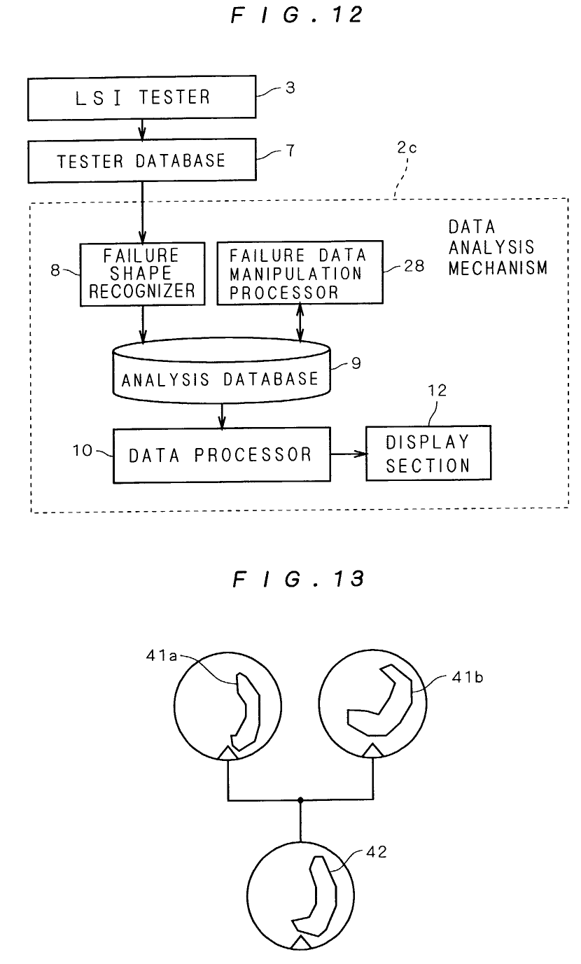

FIG. 12 is a detailed block diagram of a data analysis mechanism 2c in the semiconductor device analysis system according to a fourth preferred embodiment of the present invention. The overall configuration of the fourth preferred embodiment is similar to that of the first preferred embodiment shown in FIG. 1.

As shown in FIG. 12, a failure data manipulation processor 28 corresponding to the failure shape data generator receives data which is tested in an actual manufacturing line, recognized by the failure shape recognizer 8 and stored in the analysis database 9, that is, the failure shape recognized data about the same semiconductor device.

The failure data manipulation processor 28 extracts an arbitrary failure map based on the failure shape recognized data to analyze the characteristics of the failure data. For the extraction, the failure data manipulation processor 28 performs summation, averaging, differencing and other processes on a plurality of data. The failure data manipulation processor 28 performs a manipulation process for creating typical examples of the failure shape data having occurred in the actual manufacturing line.

FIGS. 13 and 14 illustrate examples of the manipulation process by the failure data manipulation processor 28. In the example shown in FIG. 13, a manipulated failure pattern 42 is obtained by collecting and averaging failure shape recognized data 41a and 41b which resemble each other in distribution.

In the example shown in FIG. 14, a manipulated failure pattern 44 is obtained by changing a wafer orientation so that the failure distributions of failure shape recognized data 43a and 43b whose distributions differ in direction but result from the same factor coincide with each other (more specifically, rotating the wafer for the failure shape recognized data 43b through 180 degrees), and then averaging the failures.

Thus, the failure shape data generated from the failure data manipulation processor 28 according to the fourth preferred embodiment is the data manipulated based on the failure shape recognized data associated with the defect performance of the actual manufacturing line. This allows production of a redundant configuration with defect performance of the process and the device manufacturing line in mind for circuit design, to achieve a more useful failure analysis process.

<Fifth Preferred Embodiment>

FIG. 15 is a detailed block diagram of a data analysis mechanism 2d in the semiconductor device analysis system according to a fifth preferred embodiment of the present invention. The overall configuration of the fifth preferred embodiment is similar to that of the first preferred embodiment shown in FIG. 1.

An in-line defect generator 29 outputs data corresponding to in-line inspection data. The data corresponding to the in-line inspection data is defect inspection result data about a result of defect inspection of a semiconductor device on the manufacturing line, and includes an inspection process step, chip coordinates, intra-chip coordinates from an arbitrary origin point, and a defect size. This pseudo in-line inspection data is sent to a failure converter 30. The term “defect” used herein is meant to include a conventional defect, and an equivalent of a defect inspectable by the in-line inspection apparatus 5, including a contaminant and the like.

The failure converter 30 corresponding to the failure shape data generator receives the pseudo in-line inspection data to convert the inspection process step, the intra-chip coordinates and the defect size included in the in-line inspection data into the failure shape data which designates electrical failures.

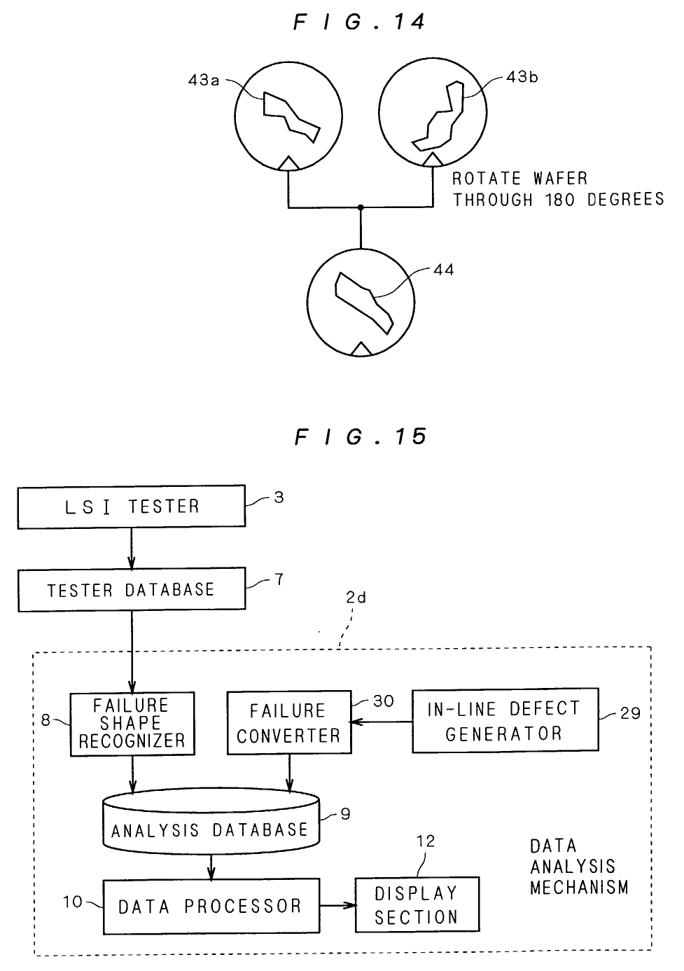

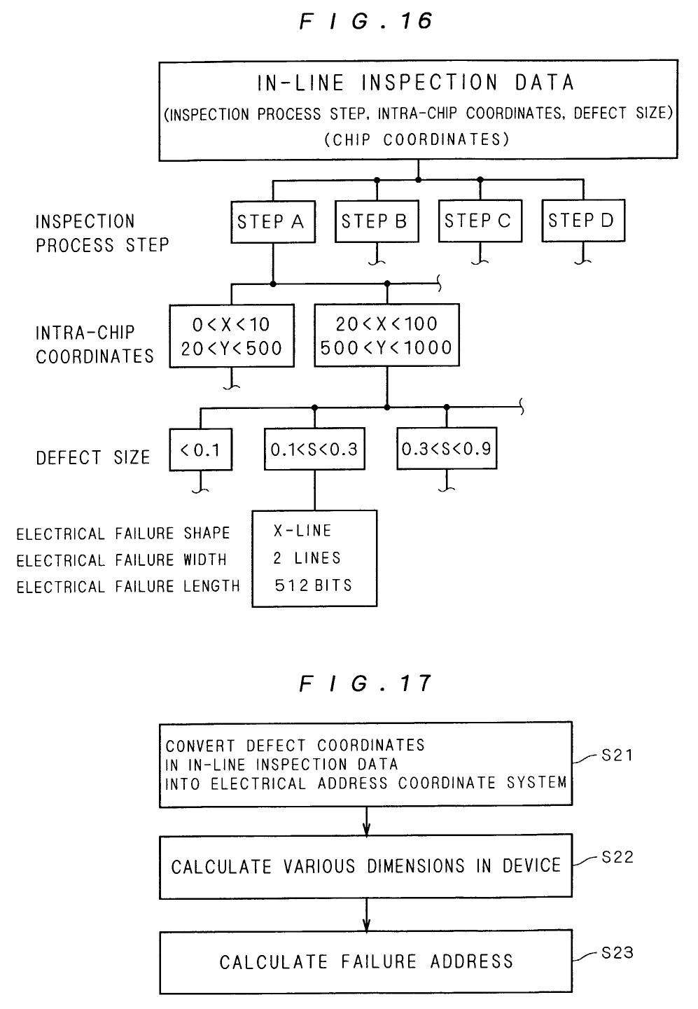

FIG. 16 illustrates the process of determining a failure shape pattern by the failure converter 30. As shown in FIG. 16, the failure shape pattern is determined based on the inspection process step, the intra-chip coordinates and the defect size designated in the in-line inspection data.

In the example of FIG. 16, a failure shape pattern having the X-line failure, an electrical failure width of two lines, and an electrical failure length of 512 bits is determined when the inspection process step is “STEP A,” the intra-chip coordinates are “20<X<100,500<Y<1000” and the defect size S (μm) is “0.1<S<0.3.”

FIG. 17 is a flowchart showing a method of calculating a failure address by the failure converter 30. The term “failure address” used herein means a failure address location in the case where the semiconductor device is a memory.

With reference to FIG. 17, the intra-chip (defect) coordinates in the in-line inspection data are converted into an address coordinate system (Xdis, Ydis), in Step S21. In this conversion process, the coordinates (Xdis, Ydis) are derived by subtracting a distance between the position of the origin point of the in-line inspection data and the position of the electrical address origin point from the intra-chip coordinates in the in-line inspection data.

Next, various dimensions in the semiconductor device are set in Step S22. For example, bit-to-bit distances or pitches P (a pitch XP in the X direction and a pitch YP in the Y direction) in the semiconductor device are previously obtained as constants from device design information. Additionally, spacings A, B, . . . between non-uniformly spaced regions such as a peripheral circuit portion, a dummy circuit and a spare interconnect line are obtained.

At the same time, the positions where the spacings A, B, . . . are present are obtained and are refereed to as n1, n2, . . . , respectively. The positions n1, n2, . . . are variables determined by an address N (either an X address or a Y address). The determination is made by, for example, n1=N/256, n2=N/128, and the like.

In Step S23, the failure address is calculated while incrementing the address N from zero, based on the various dimensions set in Step S22.

As an example, the determination of an X address of the failure address is as follows. While the X address is incremented by one from zero up to N, the X coordinate XN of the address N is calculated by XN=N·P+n1·A+n2·B+ . . . . When a difference between the X coordinate XN and the X coordinate Xdis of the in-line inspection data is less than the pitch XP in the X direction (or Xdis−XN<XP), the X coordinate XN is determined as a failure X address Xadd. A failure Y address Yadd is similarly determined.

As a result, the coordinates (Xadd, Yadd) become the failure address provided when the defect coordinates in the in-line inspection data are replaced with the electrical failure coordinates.

Thus, the failure converter 30 places the failure shape pattern obtained based on the in-line inspection data as shown in FIG. 16 at the failure address obtained by the process flow of FIG. 17, to thereby generate the failure shape data designating the electrical failure based on the in-line inspection data.

The fifth preferred embodiment includes the failure converter 30 for performing such an electrical failure conversion, to permit the influence of a defect in the in-line inspection to be grasped as the electrical failure.

<Sixth Preferred Embodiment>

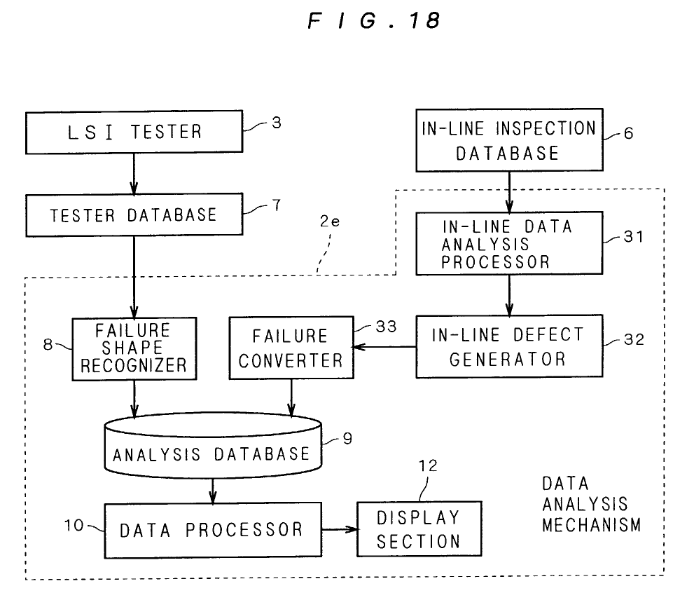

FIG. 18 is a detailed block diagram of a data analysis mechanism 2e in the semiconductor device analysis system according to a sixth preferred embodiment of the present invention. The overall configuration of the sixth preferred embodiment is similar to that of the first preferred embodiment shown in FIG. 1.

As shown in FIG. 18, the data analysis mechanism 2e differs from the data analysis mechanism 2d of the firth preferred embodiment shown in FIG. 15 in comprising an in-line data analysis processor 31 which receives actual in-line inspection data stored in the in-line inspection database 6.

The in-line data analysis processor 31 performs an analysis process including statically manipulating the actual in-line inspection data to provide an analysis result to an in-line defect generator 32. For example, the in-line data analysis processor 31 is considered to manipulate contaminant checking data in the actual in-line inspection data and product inspection data to provide the analysis result which is a typical result in corresponding relation to the in-line inspection result of the line.

The in-line defect generator 32 generates data corresponding to the actual in-line inspection data, based on the analysis result from the in-line data analysis processor 31.

As a consequence, the sixth preferred embodiment allows the in-line data analysis processor 31 to grasp the defect performance of the line obtained by the in-line inspection, based on the data corresponding to the actual in-line inspection data, to achieve circuit verification based on the in-line defect performance of the manufacturing line.

<Seventh Preferred Embodiment>

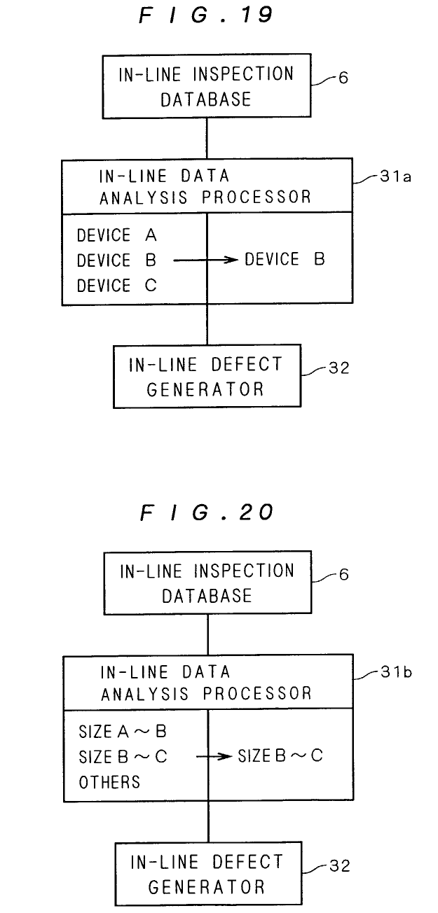

FIG. 19 illustrates the in-line data analysis processor and its peripheral sections according to a seventh preferred embodiment of the present invention. The remaining structure of the data analysis mechanism of the seventh preferred embodiment is similar to that of the sixth preferred embodiment shown in FIG. 18. The overall configuration of the seventh preferred embodiment is similar to that of the first preferred embodiment shown in FIG. 1.

All of the data obtained by the in-line inspection apparatus 5 are stored in the in-line inspection database 6. An in-line data analysis processor 31a according to the seventh preferred embodiment extracts only the actual in-line inspection data about any specified device from these data, performs an analysis process such as manipulation upon the extracted data, and then outputs the analysis result to the in-line defect generator 32. FIG. 19 shows an instance where only the actual in-line inspection data about a device B, among three devices A to C, is subjected to the analysis process. The device to be subjected to the analysis process may be specified by external application, previous setting or the like.

During the in-line inspection, device information identifying semiconductor devices is added to the actual in-line inspection data to be entered into the in-line inspection database 6.

As discussed above, the seventh preferred embodiment can extract an in-line defect peculiar to a semiconductor device to obtain the data corresponding to the in-line inspection data whose contents are suitable for failure analysis. Consequently, the semiconductor device analysis system according to the seventh preferred embodiment can perform a detailed failure analysis process related to the type of device selected.

<Eighth Preferred Embodiment>

FIG. 20 illustrates the in-line data analysis processor and its peripheral sections according to an eighth preferred embodiment of the present invention. The remaining structure of the data analysis mechanism of the eighth preferred embodiment is similar to that of the sixth preferred embodiment shown in FIG. 18. The overall configuration of the eighth preferred embodiment is similar to that of the first preferred embodiment shown in FIG. 1.

All of the data obtained by the in-line inspection apparatus 5 are stored in the in-line inspection database 6. An in-line data analysis processor 31b according to the eighth preferred embodiment extracts only a defect having any specified size from these data, performs an analysis process such as manipulation upon the extracted defect, and then outputs the analysis result to the in-line defect generator 32. FIG. 20 shows an instance where only the actual in-line inspection data about a size “B-C”, among sizes “A-B,” “B-C” and “OTHERS,” is subjected to the analysis process. The defect size to be subjected to the analysis process may be specified by external application, previous setting or the like.

As discussed above, the eighth preferred embodiment can extract an in-line defect peculiar to the size to obtain the data corresponding to the in-line inspection data whose contents are suitable for failure analysis. Consequently, the semiconductor device analysis system according to the eighth preferred embodiment can perform a detailed failure analysis process related to the selected defect size.

Characteristics of electrical failures are significantly dependent upon the defect size in extracting required information from the in-line inspection result before a failure converter 33 performs conversion into the electrical failures. It is therefore very useful to selectively analyze the actual in-line inspection data about a peculiar defect size as in the eighth preferred embodiment.

<Ninth Preferred Embodiment>

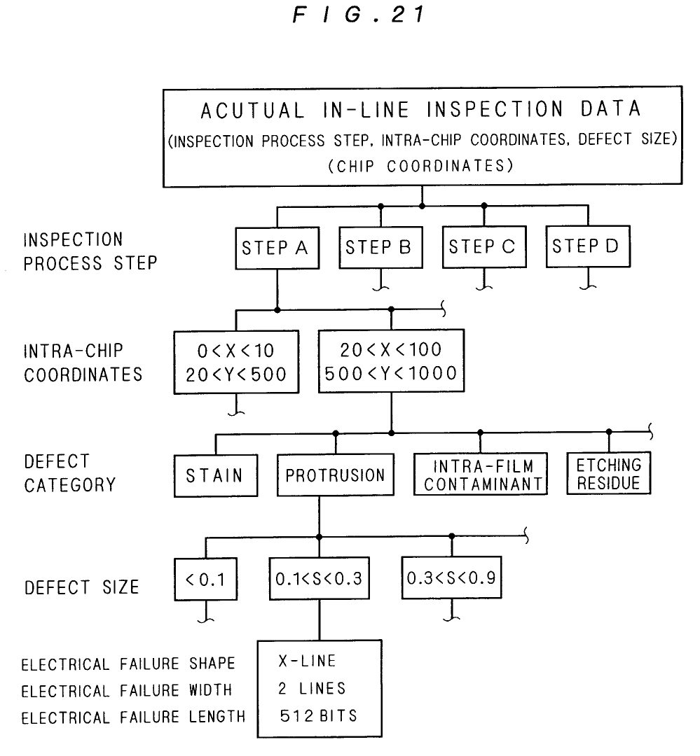

FIG. 21 illustrates the process of determining a failure shape pattern by the failure converter 30 according to a ninth preferred embodiment of the present invention. The data analysis mechanism of the ninth preferred embodiment is similar in construction to that of the sixth preferred embodiment shown in FIG. 18. The overall configuration of the ninth preferred embodiment is similar to that of the first preferred embodiment shown in FIG. 1.

All of the actual in-line inspection data obtained by the in-line inspection apparatus 5 are stored in the in-line inspection database 6. Defect shape information about the defect shape obtained by observing a position where a defect is detected in the manufacturing line by using in-line SEM or the like is added to the actual in-line inspection data.

The in-line data analysis processor according to the ninth preferred embodiment performs the analysis process based on the actual in-line inspection data to obtain the analysis result. The analysis result includes a defect category classified based on the defect shape information in the actual in-line inspection data. Examples of the defect category are shape, height, protrusion, stain, intra-film contaminants, etching residues, and the like.

The in-line defect generator 32 provides analyzed actual in-line inspection data including the defect category to the failure converter 30. The failure converter 30 determines the failure shape pattern based on the analyzed actual in-line inspection data.

Specifically, the failure converter 30 according to the ninth preferred embodiment determines the failure shape pattern, based on the inspection process step, intra-chip coordinates, defect category and defect size designated in the analyzed actual in-line inspection data.

In the example of FIG. 21, a failure shape pattern having the X-line failure, an electrical failure width of two lines, and an electrical failure length of 512 bits is determined when the inspection process step is “STEP A,” the intra-chip coordinates are “20<X<100,500<Y<1000,” the defect category is “PROTRUSION,” and the defect size S (μm) is “0.1<S<0.3.”

As described above, the in-line data analysis processor 31 according to the ninth preferred embodiment uses the defect category as an item for judgment about the conversion during the electrical failure conversion, to perform the failure analysis process based on the failure shape data with consideration given to the defect category in the actual in-line inspection data.

<Tenth Preferred Embodiment>

A tenth preferred embodiment according to the present invention extracts only a defect in any specified in-line inspection process step from the actual in-line inspection data to perform an analysis process such as manipulation upon the extracted defect.

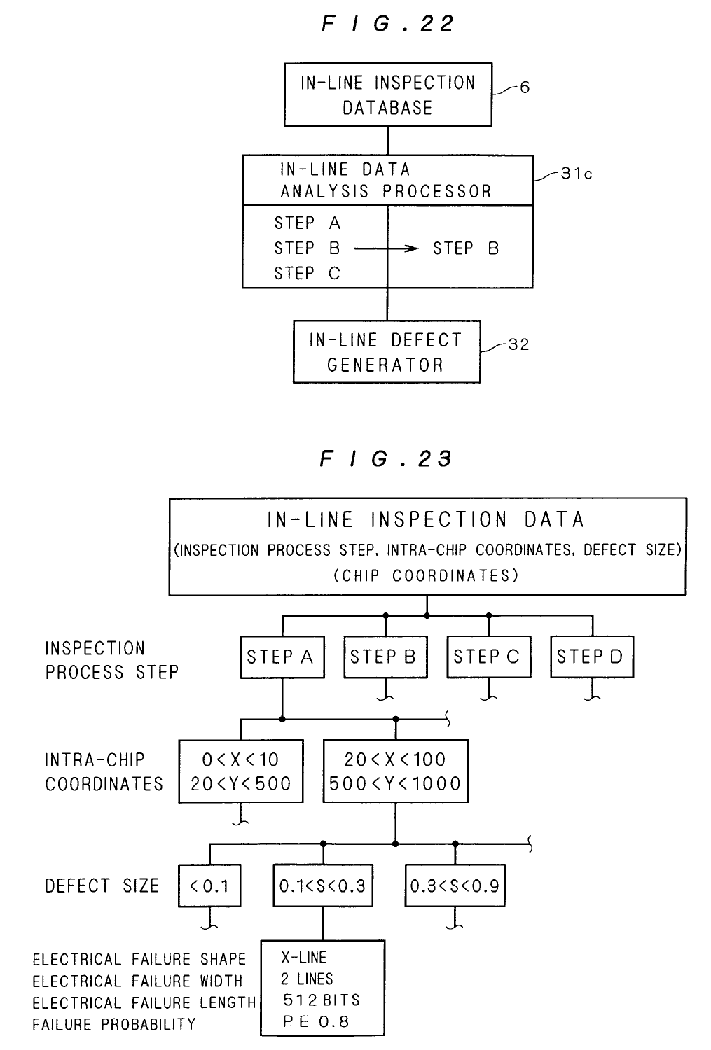

FIG. 22 illustrates the in-line data analysis processor and its peripheral sections according to the tenth preferred embodiment of the present invention. The remaining structure of the data analysis mechanism of the tenth preferred embodiment is similar to that of the sixth preferred embodiment shown in FIG. 18. The overall configuration of the tenth preferred embodiment is similar to that of the first preferred embodiment shown in FIG. 1.

All of the data obtained by the in-line inspection apparatus 5 are stored in the in-line inspection database 6. An in-line data analysis processor 31c according to the tenth preferred embodiment extracts only a defect in any specified in-line inspection process step from these data, performs an analysis process such as manipulation upon the extracted defect, and then outputs the analysis result to the in-line defect generator 32. FIG. 22 shows an instance where only the actual in-line inspection data about “STEP B,” among “(IN-LINE INSPECTION) STEPS A to C,” is subjected to the analysis process. The process step to be subjected to the analysis process may be specified by external application, previous setting or the like.

As described above, the tenth preferred embodiment carries out the analysis process on a process step by process step basis to obtain more detailed data, thereby performing a detailed failure analysis process related to the selected in-line inspection process step. A method of checking the in-line inspection data is carried out using a bare wafer. This provides the actual in-line inspection data about a contaminant checking wafer used for process control, in addition to the conventional inspection data about the actual device.

The tenth preferred embodiment, which is based on the selected in-line inspection data, can estimate the defect performance from the contaminant checking wafer in the manufacturing line and apparatus without the actual flow of devices in the line. This allows the grasp of the ability of the manufacturing line for new devices, and circuit verification.

<Eleventh Preferred Embodiment>

FIG. 23 illustrates the process of determining a failure shape pattern by the failure converter 30 according to an eleventh preferred embodiment of the present invention. The data analysis mechanism of the eleventh preferred embodiment is similar in construction to that of the sixth preferred embodiment shown in FIG. 18. The overall configuration of the eleventh preferred embodiment is similar to that of the first preferred embodiment shown in FIG. 1.

It is hard to consider that all of the defects detected by the in-line inspection for each inspection process step become electrical failures. Therefore, the eleventh preferred embodiment defines a failure occurrence probability for each combination of the inspection process step and the failure shape. Based on the failure occurrence probability, a failure is generated in a data format of the in-line inspection data and is converted by the failure converter 33. This allows the generation of a realistic electrical failure.

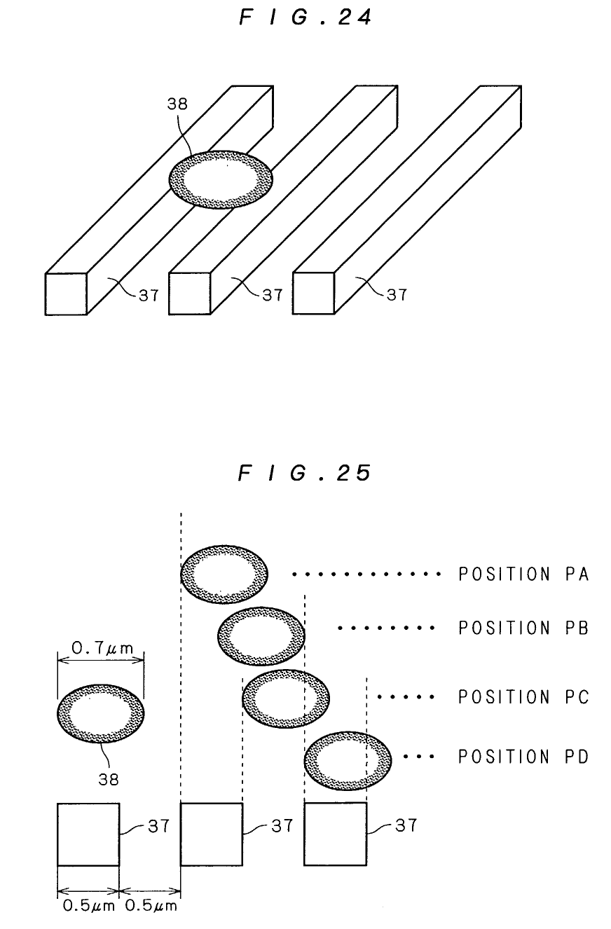

FIG. 24 schematically illustrates an electrically conductive contaminant 38 as formed on interconnect lines 37. An electrical failure occurs when the contaminant 38 (a kind of defect) having an electrical conductivity is formed in contact with adjacent ones of the interconnect lines 37, as illustrated in FIG. 24.

FIG. 25 schematically illustrates the mechanism of occurrence of a contaminant-induced failure. The location of the electrically conductive contaminant 38 in the case where the contaminant 38 causes an electrical failure will be contemplated, with reference to FIG. 25. It is assumed that the contaminant 38 has a size of 0.7 μM, and the interconnect lines 37 have a size of 0.5 μm and are spaced 0.5 μm apart from each other, for example, as shown in FIG. 25.

In this case, shifting the contaminant 38 from the position PA lying on an interconnect line 37 sequentially to the position PB, to the position PC and finally to the position PD (equivalent to the position PA) shows the following result. In the position PB, the contaminant 38 contacts the adjacent interconnect lines 37 to cause a short circuit. The short circuit is maintained until an end of the contaminant 38 in the position PC is out of contact with the middle interconnect line 37. Thereafter, the short circuit is avoided, and there is no short circuit in the position PD. In this example, the electrically conductive contaminant 38 causes the electrical failure when the contaminant 38 lies between the positions PB and PC with respect to the interconnect lines 37.

The probability PE (referred to hereinafter as a “failure probability PE”) of occurrence of electrical failures in the example of FIG. 25 is PE=(0.7−0.5)/1.0=0.2. That is, the ratio of a distance 0.2 μm (=0.7−0.5) through which the failure occurs (or a distance from the position PB to the position PC) to the distance 1.0 μn through which the contaminant 38 is shifted (or a distance from the position PA to the position PD) is calculated as the failure probability PE when the contaminant 38 occurs under the above-mentioned conditions.

Then, the failure probability PE which is information about the degree of failures may be added to the failure shape data, as shown in FIG. 23. The process of adding the failure probability PE may be performed in a manner as described above either by the in-line data analysis processor 31 or by the failure converter 33.

As stated above, the eleventh preferred embodiment establishes the failure probability PE when converting the contaminant size, the category and the process step into the electrical failure, to produce the effect of generating the failures closer to those of the actual devices when automatically generating the failures by using the data corresponding to the in-line inspection data.

While the invention has been described in detail, the foregoing description is in all aspects illustrative and not restrictive. It is understood that numerous other modifications and variations can be devised without departing from the scope of the invention.

What is claimed is:

1. A semiconductor device analysis system having a data analysis mechanism for analyzing a failure location and a failure shape in a semiconductor device, said data analysis mechanism comprising:
a failure shape data generator for artificially generating failure shape data specifying the shape of a failure in a device; and
a failure analysis processor for performing a failure analysis process based on said failure shape data.

2. The semiconductor device analysis system according to claim 1, wherein
said failure shape data generator includes a failure generator receiving indication information indicating details of failure generation of said failure shape data and for generating said failure shape data based on said indication information.

3. The semiconductor device analysis system according to claim 2, wherein
said indication information includes information indicating the type of failure shape.

4. The semiconductor device analysis system according to claim 2, wherein
said indication information includes information designating a wafer distribution and a chip distribution, said wafer distribution being a distribution of failure chips on a wafer, said chip distribution being a distribution of failures in a chip; and
said failure shape data generator includes failure generator for generating said failure shape data conforming to said wafer distribution and said chip distribution indicated by said indication information.

5. The semiconductor device analysis system according to claim 1, wherein
said data analysis mechanism further includes an analysis database for storing failure shape recognized data which is recognized as a failure shape, based on a result of a test of a semiconductor device for electrical failure; and
said failure shape data generator includes a failure data manipulation processor for manipulating said failure shape recognized data to generate said failure shape data.

6. The semiconductor device analysis system according to claim 1, wherein
said data analysis mechanism further includes an in-line defect generator for generating data corresponding to in-line inspection data which is defect inspection result data about a semiconductor device on a predetermined manufacturing line; and
said failure shape data generator includes a failure converter for converting said data corresponding to said in-line inspection data into said failure shape data designating an electrical failure to generate said failure shape data.

7. The semiconductor device analysis system according to claim 6, wherein
said data corresponding to said in-line inspection data includes data associated with actual in-line inspection data which is actual inspection data obtained on a predetermined manufacturing line.

8. The semiconductor device analysis system according to claim 7, wherein
said data analysis mechanism further includes an in-line data analysis processor receiving said actual in-line inspection data and for performing a predetermined analysis process to obtain analyzed actual in-line inspection data; and
said in-line defect generator generates said in-line inspection data, based on said analyzed actual in-line inspection data.

9. The semiconductor device analysis system according to claim 8, wherein
said predetermined analysis process includes a selection process based on the type of device provided in an in-line inspection.

10. The semiconductor device analysis system according to claim 8, wherein
said predetermined analysis process includes a selection process based on a defect size provided in an in-line inspection.

11. The semiconductor device analysis system according to claim 8, wherein
said predetermined analysis process includes a process of identifying the type of defect in an in-line inspection.

12. The semiconductor device analysis system according to claim 8, wherein
said predetermined analysis process includes a selection process based on an in-line inspection process step.

13. The semiconductor device analysis system according to claim 6, wherein
said failure shape data includes data with information about the degree of failure added thereto.
